(19) United States
(12) Patent Application Publication
(10) Pub. No.: US 2016/0183229 A1
(43) Pub. Date: Jun. 23, 2016

(54) IP PHONE NETWORK SYSTEM, SERVER APPARATUS, IP EXCHANGE AND RESOURCE CAPACITY EXPANSION METHOD

(71) Applicant: KABUSHIKI KAISHA TOSHIBA, Minato-ku (JP)

(72) Inventor: Hideaki Nakai, Hino (JP)

(73) Assignee: KABUSHIKI KAISHA TOSHIBA, Minato-ku (JP)

(21) Appl. No.: 14/976,588

(22) Filed: Dec. 21, 2015

(30) Foreign Application Priority Data
Dec. 22, 2014 (JP) 2014-258515

(51) Int. Cl. H04W 72/04; H04M 7/00

(52) U.S. Cl. CPC H04W 72/044; H04M 7/006

(57) ABSTRACT

According to one embodiment, an IP phone network system is a system where an IP exchange accommodating a plurality of IP devices and providing communication services thereto is connected through a network to a server device forming a virtual machine. In accordance with extension of a resource capacity for the IP exchange, resources necessary for providing the communication services to the IP exchange are clustered, and part or all of the clustered resources is allocated to the virtual machine in the server device.

### CROSS-REFERENCE TO RELATED APPLICATIONS

This application is based upon and claims the benefit of priority from Japanese Patent Application No. 2014-258515, filed Dec. 22, 2014, the entire contents of which are incorporated herein by reference.

### FIELD

Embodiments described herein relate generally to an Internet protocol (IP) phone network system, and a server apparatus, an IP exchange and a resource capacity expansion method for use in the system.

### BACKGROUND

In the conventional IP phone network system, when there is a demand for extending the capacity of resources, such as addition of devices accommodated (in other words, placed under control”) in an IP exchange, this IP exchange is replaced with an IP exchange of a large resource capacity as a whole. However, depending on the scale of extension, an IP exchange of a small resource capacity must be replaced with an IP exchange of a resource capacity larger than necessary, which requires extra cost.

The embodiment has been developed under these circumstances, and aims to provide an IP phone network system capable of easily and flexibly compensating for shortage of a resource capacity without replacing an IP exchange.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing the configuration of an IP phone network system according to an embodiment.

FIG. 2 is a block diagram showing a specific configuration example of the IP phone network system according to an embodiment.

FIGS. 3A and 3B are views showing an example of an arrangement of call control resources employed in the system of the embodiment when the number of voicemail ports is increased.

FIGS. 4A and 4B are views showing an example of an arrangement of media resources employed in the system of the embodiment when the number of mailboxes with priority A is increased.

FIG. 5 is a view showing a sequence example of processing executed when a voicemail virtual machine is generated by increasing the number of voicemail ports and the number of mailboxes included in an IP exchange (premises side) employed in the system of the embodiment.

FIG. 6 is a view showing a sequence example (1) of call control by the voicemail virtual machine in the system of the embodiment (where the voicemail ports and mailboxes both exit on a cloud side).

FIG. 7 is a view showing a sequence example (2) of call control by the voicemail virtual machine in the system of the embodiment (where the voicemail ports exist in the cloud and the mailboxes exit on the premises side).

FIG. 8 is a view showing a sequence example (3) of call control by the voicemail virtual machine in the system of the embodiment (where the voicemail ports exist on the premises side and the mailboxes exit on the cloud side).

FIG. 9 is a block diagram showing a specific example employed in the system of the embodiment when the IP exchange is realized by software.

### DETAILED DESCRIPTION

Various embodiments will be described hereinafter with reference to the accompanying drawings.

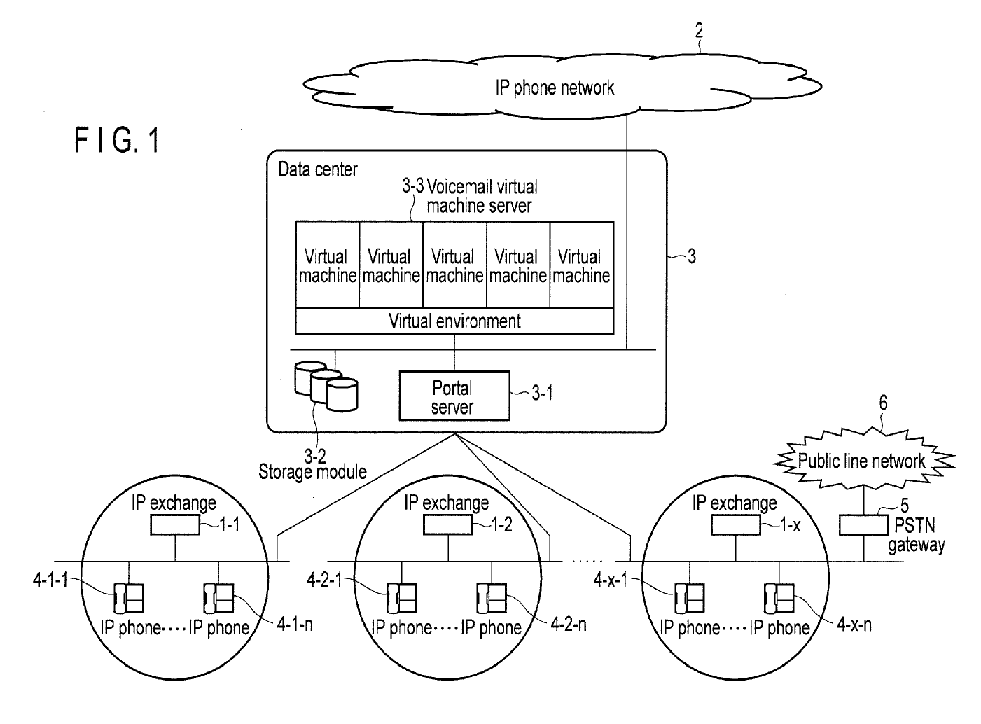

FIG. 1 is a block diagram showing the configuration of an IP phone network system according to the embodiment. In FIG. 1, the IP phone network system comprises a plurality of IP exchanges (nodes) 1-i (i is 1, 2, . . x) functioning as premises devices, and a data center server (hereinafter, referred to as a data center) 3 that directly accommodates a plurality of IP exchanges 1-i or accommodates a large number of IP exchanges (not shown) via an IP phone network 2, and functions as a cloud (virtual machine). Each IP exchange 1-i can accommodate a plurality of IP phones 4-i-j (j is 1, 2, . . n). For example, IP exchange 1-1 can accommodate IP phones 4-1-1, 4-1-2, . . 4-1-n, where n is set to an arbitrary value in each IP exchange 1-i. In each IP exchange 1-i, IP phone 4-i-j can make an extension call with another IP phone in the same node, and calls with a public line network 6 via a public switched telephone network (PSTN) gateway 5. Further, the data center 3 comprises a portal server 3-1 for accommodating IP exchanges 1-i, a data storage module 3-2 for a control data table, a mailbox, etc., and a voicemail virtual machine server 3-3 for generating and managing a voicemail virtual machine in a virtual environment.

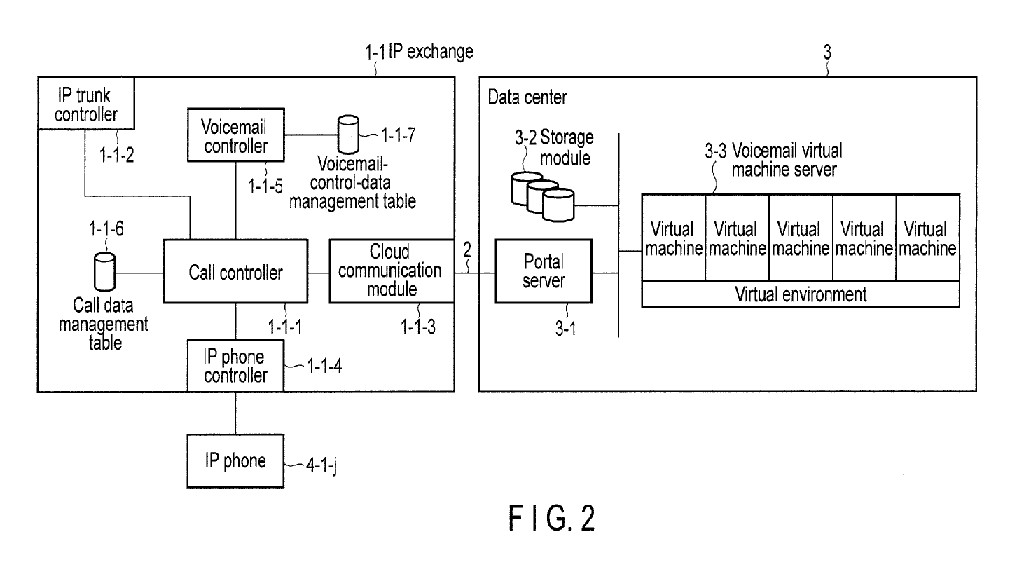

FIG. 2 is a block diagram showing the configuration of the control system of IP exchange 1-1. Since other IP exchange 1-2, . . 1-x have the same configurations as IP exchange 1-1, no description will be given thereof. In FIG. 2, IP exchange 1-1 comprises call controller 1-1-1, IP trunk controller 1-1-2, cloud communications module 1-1-3, IP phone controller 1-1-4, voicemail controller 1-1-5, call-control-data management table 1-1-6, and voicemail-control-data management table 1-1-7. Call controller 1-1-1 manages data indicating the terminal attributes, resource arrangement, etc., of ports, such as IP phone 4-1-j and voicemail ports, using call-control-data management table 1-1-6, and performs call control processing of IP phones and IP trunks, based on the management data. IP trunk controller 1-1-2 is an interface for adding, to an in-plant exchange, a function of changing audio into IP packets in communication with an IP trunk, thereby putting the exchange under control of call controller 1-1-1. Cloud communication module 1-1-3 is an interface for enabling the data center 3 on the cloud side with call controller 1-1-1 on the premises side. IP phone controller 1-1-4 is an interface for adding, to an in-plant exchange, a function of changing audio into IP packets in communication with an IP phone, thereby putting the phone under control of call controller 1-1-1. Voicemail controller 1-1-5 manages data indicating the box number, priority degree, resource arrangement, etc., of a respective mailbox when generating the respective mailbox, and provides voicemail services, such as message recording/playback and call recording, using voicemail-control-data management table 1-1-7.

In consideration of a processing delay due to an increase in network traffic between IP exchange functioning as a premises device and the data center 3 functioning as a cloud, the above-described IP phone network system imparts, to the premises side, a call control function for voicemail services, a function of managing free/occupied states and priority degrees of call control/media resources, and a function of generating a virtual machine (a cloud) when resources should be added. Further, the IP phone network system executes, for the cloud side, generation of a virtual machine, acquisition/release of resources necessary for voicemail services, provision of voicemail services, etc., in accordance with an instruction from the premises side. Furthermore, regarding resources, the IP phone network system imparts, to the IP exchange (premises) side, a function of determining whether an additional or target resource should be allocated to the premises side or to the cloud side, in accordance with the capacity of the additional resource or the degree of priority of a user who uses an IP phone corresponding to the target resource. Since management data corresponding to various services provided by the IP exchange in addition to the voicemail services is necessary as a resource, the amount of use of a memory may become enormous in accordance with the number of additional resources. For this reason, resources may be allocated to the cloud side in view of scalability. Moreover, in view of security, media resources may be allocated such that resources used by a user of a low priority degree are allocated to the cloud side, and resources used by a user of a high priority degree are allocated to the premises side.

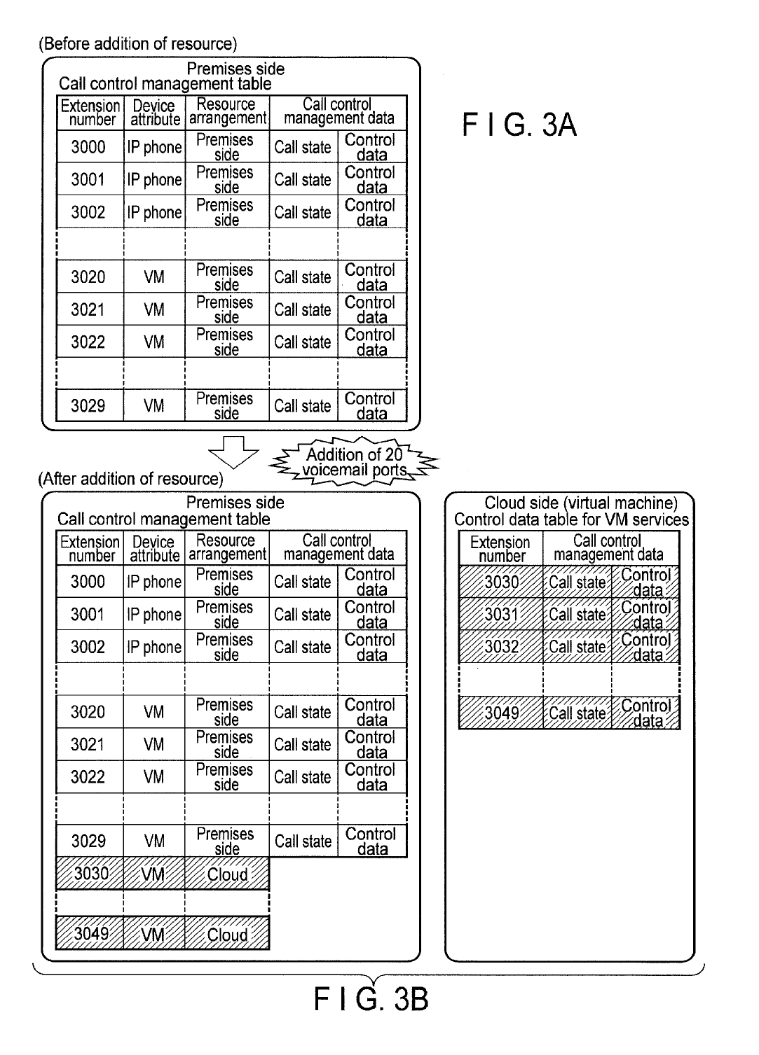

FIGS. 3A and 3B show an example of a call control resource arrangement assumed when the number of voicemail ports is increased. FIG. 3A shows a call control resource arrangement example of call-control-data management table 1-1-6 in a state where call control data corresponding to 30 ports are managed on the premises side. FIG. 3B shows a call control resource arrangement example of call-control-data management table 1-1-6 and a call control resource arrangement example of a virtual machine generated on the cloud side, assumed when an instruction to add 20 voicemail ports is issued. In these examples, call controller 1-1-1 of IP exchange 1-1 manages the terminal attributes or resource arrangements of ports, such as IP phone 4-1-j and voicemail ports, using call-control-data management table 1-1-6. When 20 voicemail ports should be added to IP exchange 1-1, it is determined whether all newly added voicemail ports should be allocated to the cloud side, in consideration of the memory residual quantity of IP exchange 1-1. If it is determined that all should be allocated to the cloud side, the call controller instructs the voicemail virtual machine server 3-3 of the data center 3 to generate a voicemail virtual machine and a control data table for voicemail services, and sets an extension number and a terminal attribute in call-control-data management table 1-1-6, and sets a cloud as resource arrangement data associated with each port. Furthermore, after generation of the virtual machine, the area of all added voicemail ports is allocated to the voicemail service control data table generated by the data storage module 3-2 of the data center 3.

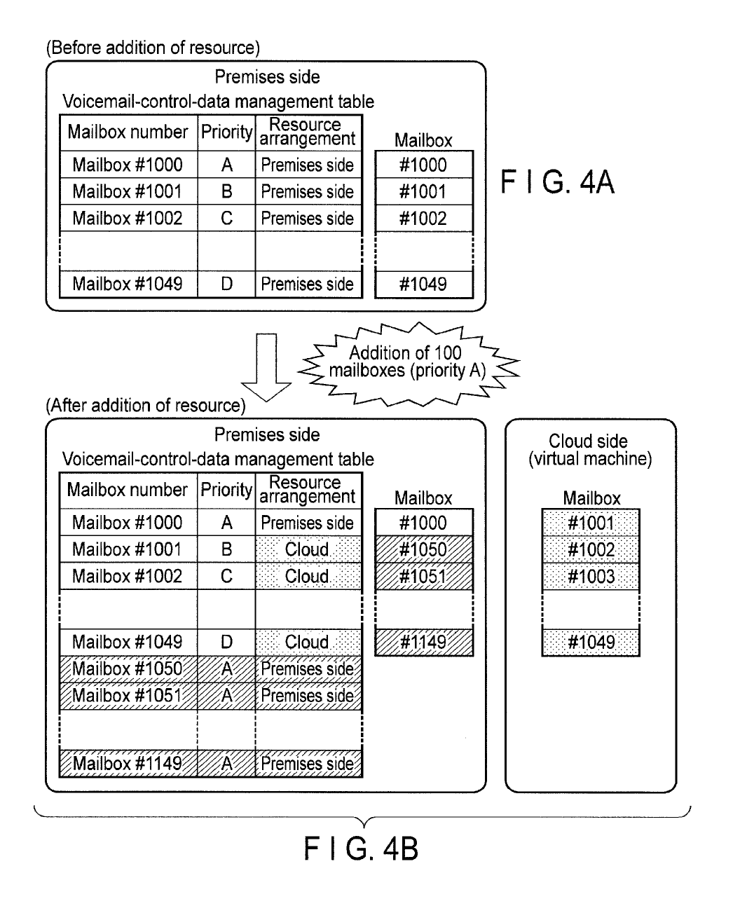

FIGS. 4A and 4B show examples of a media resource arrangement assumed when the number of mailboxes is increased. FIG. 4A shows a media resource arrangement example of voicemail-control-data management table 1-1-7 in a state where 50 mailboxes are managed on the premises side. FIG. 4B shows a media resource arrangement example of voicemail-control-data management table 1-1-7 and a media resource arrangement example of a virtual machine generated on the cloud side, assumed when an instruction to add 100 mailboxes is issued. In these examples, voicemail controller 1-1-5 of IP exchange 1-1 manages the priority degree and resource arrangement of each mailbox, using voicemail-control-data management table 1-1-7. If IP exchange 1-1 is instructed to add 100 mailboxes of priority A, it generates, in view of the memory residual amount, the mailboxes after setting newly added mailbox numbers and priority degrees in voicemail-control-data management table 1-1-7, and setting premises for the resource arrangement data of each mailbox, because the priority degrees of the newly added mailboxes are high. Furthermore, regarding mailboxes of low priority allocated to the premises side until now, IP exchange 1-1 changes, to the cloud, the resource arrangement data of those mailboxes in voicemail-control-data management table 1-1-7, and newly generates, on the cloud side, mailboxes allocated so far to the premises side, after generating a virtual machine.

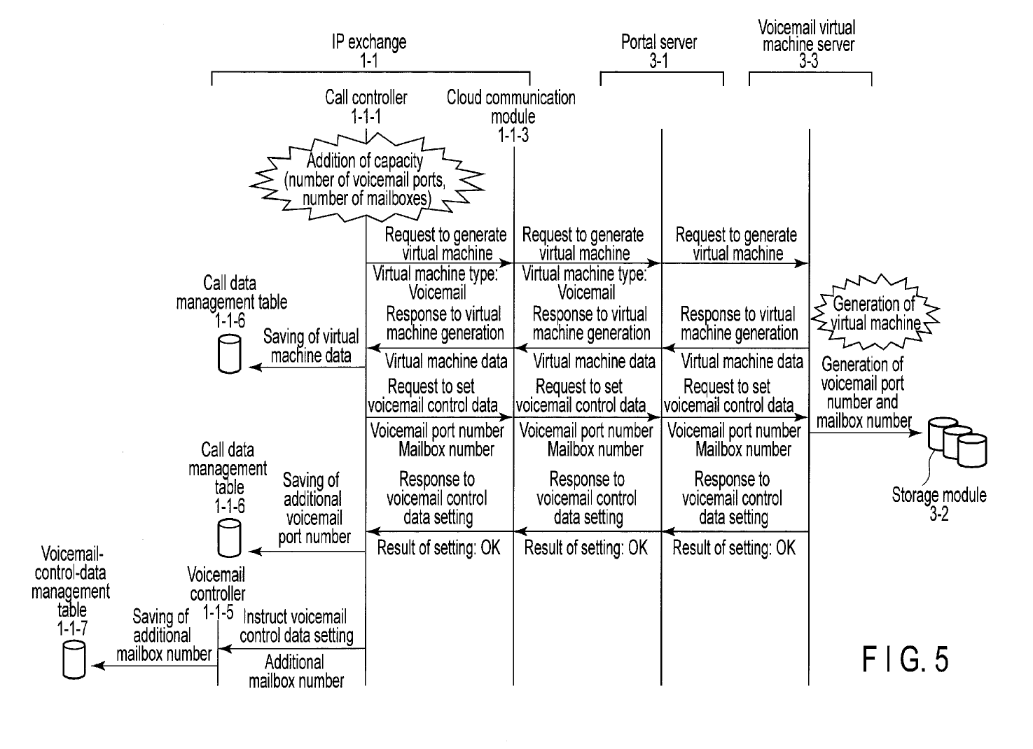

FIG. 5 shows a sequence example of processing executed when IP exchange 1-1 instructs the portal server 3-1 on the cloud to generate a virtual machine for voicemail services, where the numbers of voicemail ports and mailboxes must be increased. Upon occurrence of a request, to IP exchange 1-1, to add resources necessary for voicemail services, such as addition of voicemail ports and/or mailboxes, call controller 1-1-1 transmits a virtual-machine generation request message to the portal server 3-1 on the cloud through cloud communication module 1-1-3. The portal server 3-1 transmits a virtual machine generation request message to the voicemail virtual machine server 3-3 in accordance with virtual machine type data set in the message. Upon receiving the message, the voicemail virtual machine server 3-3 generates a virtual machine, and returns, to IP exchange 1-1 through the portal server 3-1, a virtual-machine-generation response message wherein an IP address, for example, assigned to the generated virtual machine is set. IP exchange 1-1 transmits the message to call controller 1-1-1 through cloud communication module 1-1-3. Call controller 1-1-1 extracts data, such as the IP address of the virtual machine, from a message, and saves it in call-control-data management table 1-1-6. Subsequently, call controller 1-1-1 transmits, to the portal server 3-1 on the cloud through cloud communication module 1-1-3, a voicemail-control-data setting request message wherein added voicemail port numbers and/or mailbox numbers are set. Upon receiving the message, the portal server 3-1 generates added voicemail ports and/or mailboxes in the storage module 3-2, and returns a voicemail-control-data setting response message to IP exchange 1-1. Upon receiving the message, IP exchange 1-1 transmits the message to call controller 1-1-1 through cloud communication module 1-1-3. Call controller 1-1-1 extracts the result of the setting response from the input message. If permission is obtained, call controller 1-1-1 saves the added voicemail port numbers in call-control-data management table 1-1-6, and then transmits, to voicemail controller 1-1-5, a voicemail-control-data setting instruction message wherein the added mailbox numbers are set. Upon receiving the message, voicemail controller 1-1-5 saves the added mailbox numbers in voicemail-control-data management table 1-1-7.

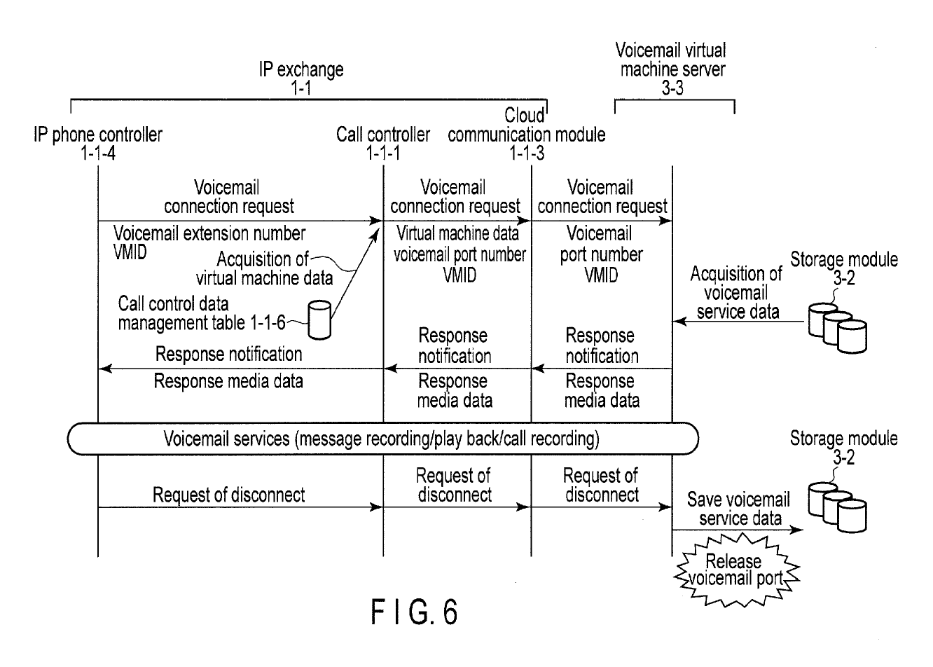

FIG. 6 shows an example of a call control sequence executed when voicemail services are provided using a voicemail port and a mailbox generated on the cloud side. Upon receiving a voicemail connection request message from IP phone 4-1-j through IP phone controller 1-1-4, call controller 1-1-1 determines, from a voicemail extension number and VMID (voicemail ID) set in the message, that a corresponding voicemail port and mailbox both exist in the cloud, thereby setting, as the voicemail connection request message, virtual machine data acquired from call-control-data management table 1-1-6, and transmitting the message to cloud communication module 1-1-3. Upon receiving the message, cloud communication module 1-1-3 transmits a voicemail connection request to the voicemail virtual machine server 3-3 corresponding to the virtual machine data. The voicemail virtual machine server 3-3 transmits a response notification message to call controller 1-1-1 through cloud communication module 1-1-3, after acquiring necessary voicemail service data from the storage module 3-2, using VMID as key data. Furthermore, call controller 1-1-1 transmits the message to IP phone controller 1-1-4, whereby IP phone 4-1-j can use voicemail services, such as message recording, playback and call recording, through the cloud. Thus, voicemail service data, such as recorded message, can be stored in the storage module 3-2. After that, if IP phone 4-1-j performs a call-ending operation, IP phone controller 1-1-4 generates a disconnect request message, and transmits it to the voicemail virtual machine server 3-3 through call controller 1-1-1 and cloud communication module 1-1-3, thereby releasing the voicemail port.

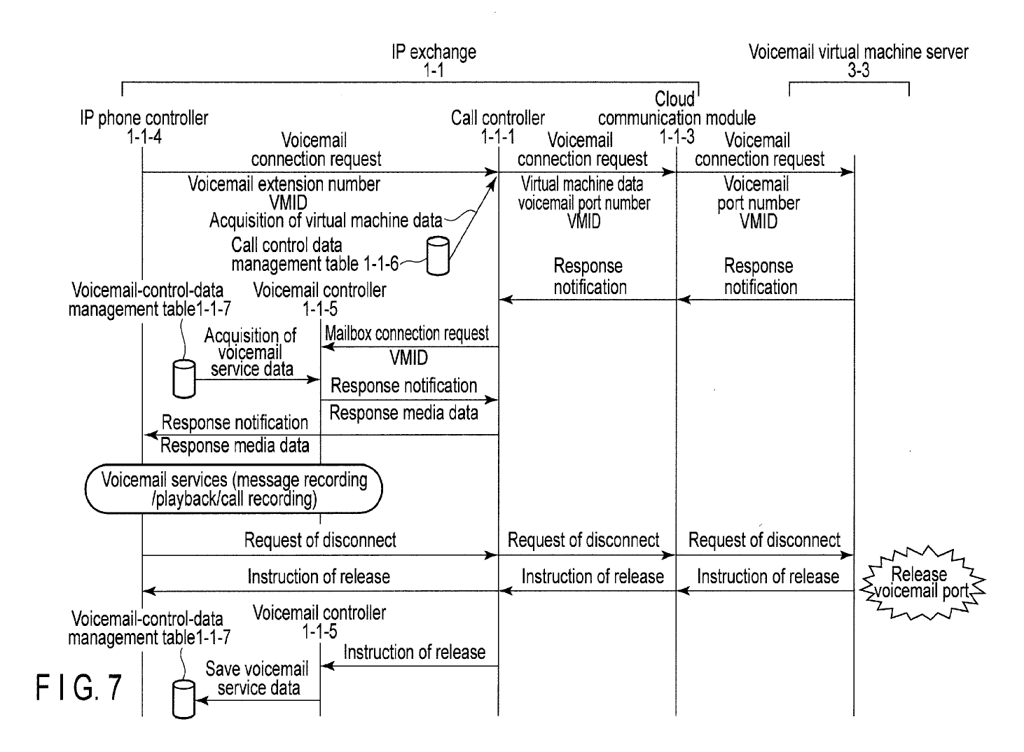

FIG. 7 shows an example of a call control sequence executed when a voicemail service is provided during a certain call, using a voicemail port generated on the cloud side and a mailbox on the premises side. Upon receiving a voicemail connection request message from IP phone 4-1-j through IP phone controller 1-1-4, call controller 1-1-1 determines, from a voicemail extension number and VMID set in the message, that the voicemail port exists on the cloud side, and the mailbox exists on the premises side, thereby setting, as the voicemail connection request message, virtual machine data acquired from call-control-data management table 1-1-6, and transmitting it to cloud communication module 1-1-3. Upon receiving the message, cloud communication module 1-1-3 transmits a voicemail connection request to the voicemail virtual machine server 3-3 corresponding to the virtual machine data. Since no VMID is set in the message, the voicemail virtual machine server 3-3 transmits a response notification message to call controller 1-1-1 through cloud communication module 1-1-3, without acquiring voicemail service data from the storage module 3-2.

Subsequently, call controller 1-1-1 transmits, to voicemail controller 1-1-5, a mailbox connection request message wherein VMID is set. Upon receiving the message, voicemail controller 1-1-5 acquires necessary voicemail service data from voicemail-control-data management table 1-1-7, using VMID as key data, and then transmits a response notification message to call controller 1-1-1. Furthermore, call controller 1-1-1 transmits the message to IP phone controller 1-1-4. Thus, IP phone 4-1-j can use voicemail services, such as message recording/playback and call recording, provided by the premises side, using a voicemail control port on the cloud. After performing a call ending operation, IP phone 4-1-j generates a disconnect request message, and transmits it to the voicemail virtual machine server 3-3 through call controller 1-1-1 and cloud communication module 1-1-3. At this time, the voicemail virtual machine server 3-3 releases the voicemail port, and generates a release message, thereby transmitting the message to call controller 1-1-1 through cloud communication module 1-1-3. Call controller 1-1-1 transmits the release message to voicemail controller 1-1-5. Upon receiving the message, voicemail controller 1-1-5 saves voicemail service data, such as a recorded message, in voicemail-control-data management table 1-1-7.

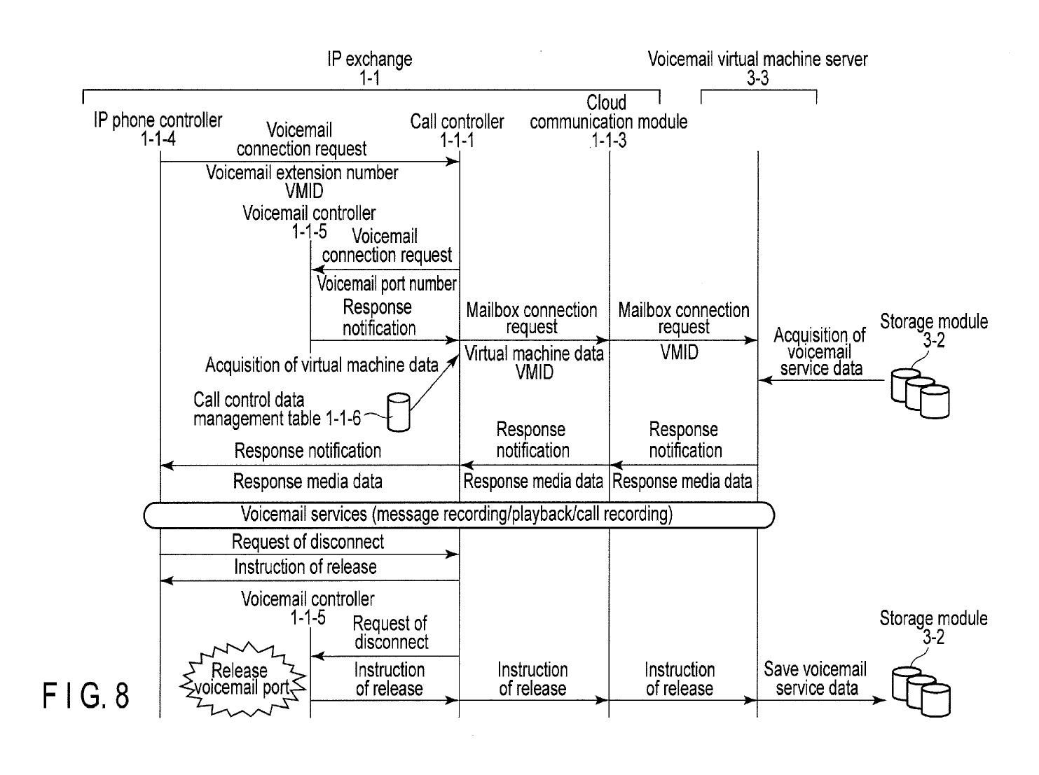

FIG. 8 shows an example of a call control sequence executed during a single call to provide voicemail services using a voicemail port on the premises side, and a mailbox generated on the cloud side. Call controller 1-1-1, which has received a voicemail connection request message from IP phone 4-1-j through IP phone controller 1-1-4, determines, from a voicemail extension number set in the message and VMID, that the voicemail port exists on the premises side and the mailbox exists on the cloud side, and transmits the voicemail connection request message to voicemail controller 1-1-5. Since no VMID is set in the message, voicemail controller 1-1-5 returns a response notification message to call controller 1-1-1, without acquiring voicemail service data from voicemail-control-data management table 1-1-7. Subsequently, call controller 1-1-1 sets virtual machine data, acquired from call-control-data management table 1-1-6, as a mailbox connection request message, and transmits the message to cloud communication module 1-1-3. Upon receiving the message, cloud communication module 1-1-3 transmits a mailbox connection request to the voicemail virtual machine server 3-3 in accordance with the virtual machine data set in the received message. Upon receiving the message, the voicemail virtual machine server 3-3 transmits a response notification message to call controller 1-1-1, after acquiring necessary voicemail service data from the storage module 3-2, using VMID as key data. At this time, call controller 1-1-1 transmits the message to IP phone controller 1-1-4. This enables an IP phone to use voicemail services, such as message recording, playback and call recording, provided by the cloud side, using a voicemail control port on the premises side. After that, if an IP phone performs an ending operation, IP phone 4-1-j generates a disconnect request message, and transmits it to voicemail controller 1-1-5 through call controller 1-1-1. In response to the disconnect request, voicemail controller 1-1-5 releases the voicemail port. Thereafter, a release instruction message is generated, and is transmitted to the voicemail virtual machine server 3-3 through cloud communication module 1-1-3. The voicemail virtual machine server 3-3 saves voicemail service data, such as a recorded message, in the storage module 3-2 in accordance with the instruction of the release instruction message.

As described above, in the embodiment, attention is focused on voicemail services provided by an IP exchange, and the voicemail services are provided using clustered resources. However, the clustered resources are not limited to voicemail services, but may include, for example, media resources used for other services, such as conference or paging services, provided by the IP exchange, and may be processed by control processing by a conference service controller, a paging service controller, etc. Further, the embodiment may be modified such that a virtual machine and data are synchronized between the premises side and the cloud side, services are usually provided from the cloud, and are provided without disconnect from the premises side when a failure occurs on the cloud side.

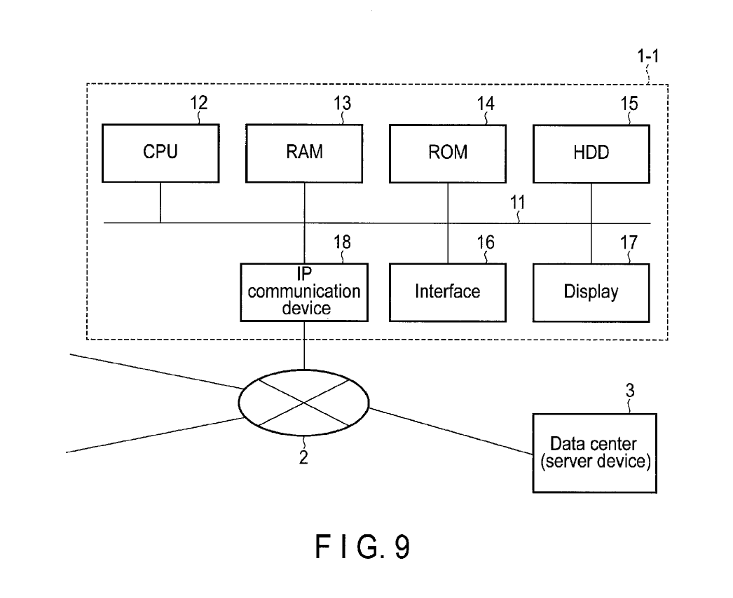

In addition, IP exchange 1-i used in the above-described system can be realized by executing software using a computer having a configuration shown in FIG. 9. In FIG. 9, reference number 11 denotes a bus line, which is connected to a central processing unit (CPU) 12 for controlling the whole apparatus, a random access memory (RAM) 13 serving as a work area and storing data, a read only memory (ROM) 14 storing a program that causes the CPU 12 to execute control processing, a hard disk drive (HDD) 15 for storing acquired data and processing data, an interface (I/F) 16 accommodating a plurality of IP phones, a display 17 for displaying acquired data or processing results, and an IP communication device 18 for exchanging data with the data center 3. The above-mentioned ROM 13 stores control programs for call controller 1-1-1, IP trunk controller 1-1-2, cloud communication module 1-1-3, IP phone controller 1-1-4 and voicemail controller 1-1-5, which are shown in FIG. 2, and a resource extension program for executing the resource extension method of the embodiment. The HDD 15 stores call-control-data management table 1-1-6 and voicemail-control-data management table 1-1-7 shown in FIG. 2. Upon receiving an instruction to execute resource extension, the CPU 12 loads a resource extension program from the ROM 13, and executes resource extension processing in cooperation of the data center 3. Thus, in a computer that controls IP exchange 1-i, resource extension utilizing a cloud can be easily realized by storing the above-mentioned resource extension program in the ROM 13.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An IP phone network system comprising:
an IP exchange accommodating a plurality of Internet protocol (IP) devices and configured to provide communication services; and
a server device accommodating the IP exchange through a network and configured to form a virtual machine of the IP exchange,
wherein resources necessary for providing the communication services to the IP exchange are clustered, and part or all of the clustered resources is allocated to the virtual machine in the server device.

2. The IP phone network system of claim 1, wherein the virtual machine corresponding to the IP exchange is added to the server device in accordance with a resource capacity extension request to the IP exchange.

3. The IP phone network system of claim 2, wherein at least extended part of the resources is allocated to the added virtual machine.

4. The IP phone network system of claim 2, wherein the clustered resources are allocated to the IP exchange and the virtual machines, based on preset degrees of priority.

5. The IP phone network system of claim 1, wherein when the communication services provided by the IP exchange include call control and media control, a resource for the call control and a resource for the media control are clustered, and are allocated to both or one of the IP exchange and the virtual machine.

6. A server device, for use in an IP phone network system, accommodating, through a network, an Internet protocol (IP) exchange that accommodates a plurality of IP devices and provides communication services, the server device comprising:
a virtual machine forming module configured to form a virtual machine of the IP exchange; and
an allocation module configured to allocate, to the virtual machine, part or all of resources clustered and necessary for the IP exchange to provide the communication services.

7. The server device of claim 6, wherein the virtual machine forming module adds a virtual machine to the IP exchange in accordance with a resource capacity extension request to the IP exchange.

8. The server device of claim 7, wherein at least extended part of the resources is allocated to the added virtual machine.

9. The server device of claim 7, wherein the clustered resources are allocated to the virtual machines, based on preset degrees of priority.

10. The server device of claim 6, wherein when the communication services provided by the IP exchange include call control and media control, and a resource for the call control and a resource for the media control are clustered, the allocation module allocates, to the virtual machine, at least part of the resources for the call control and the media control.

11. An IP exchange, for use in an IP phone network system, connected through a network to a service device forming a virtual machine, and configured to accommodate a plurality of Internet protocol (IP) devices and provide communication services to the devices, the IP exchange comprising:
a virtual machine request module configured to request the server device to form a virtual machine; and
an instruction module configured to instruct the server device to cluster resources for the communication services into clusters, and to allocate part or all of the clusters to the virtual machine.

12. The server device of claim 11, wherein the instruction module instructs the server device to add a virtual machine to the IP exchange, in accordance with the resource capacity extension request.

13. The server device of claim 12, wherein at least an extended capacity of the resources is allocated to the added virtual machine.

14. The server device of claim 12, wherein the clustered resources are allocated to the virtual machines based on preset degrees of priority.

15. The server device of claim 11, wherein when the communication services include call control and media control, the instruction module instructs the server device to cluster resources for the call control and resources for the media control into clusters, and to allocate the clustered resources to the virtual machine.

16. A resource capacity extension method, corresponding to capacity extension of resources for an Internet protocol (IP) exchange, for use in an IP phone network system which accommodates a plurality of IP devices, and in which the IP exchange is connected through a network to a server device configured to form a virtual machine for providing communication services, the resource capacity extension method comprising:
clustering resources necessary for the communication services provided by the IP exchange, and allocating part or all of the clustered resources to the virtual machine of the server device.

17. The resource capacity extension method of claim 16, further comprising causing the server device to add a virtual machine to the IP exchange in accordance with a request to extend the resources.

18. The resource capacity extension method of claim 17, wherein at least extended part of the resources is allocated to the added virtual machine.

19. The resource capacity extension method of claim 17, wherein the clustered resources are allocated to the virtual machines, based on preset degrees of priority.

20. The resource capacity extension method of claim 16, wherein when the communication services provided by the IP exchange include call control and media control, a resource for the call control and a resource for the media control are clustered, and are allocated to the virtual machine.
